(19) United States
(12) Patent Application Publication
(10) Pub. No.: US 2024/0296504 A1
(43) Pub. Date: Sep. 5, 2024

(54) FINANCIAL DATA STORAGE AND ANALYSIS PLATFORM FOR HEALTHCARE INDUSTRY PROFESSIONALS AND PRACTICES

(71) Applicant: Taskdent LLC

(72) Inventor: Ali Bayat, Dallas, TX (US)

(21) Appl. No.: 18/386,172

(22) Filed: Nov. 1, 2023

Related U.S. Application Data
(60) Provisional application No. 63/449,485, filed on Mar. 2, 2023.

(51) Int. Cl. G06Q 40/12; G06Q 10/0639; G06Q 50/22

(52) U.S. Cl. CPC G06Q 40/12; G06Q 10/06393; G06Q 50/22

(57) ABSTRACT

A software-based computer system for monitoring business and personal numbers used by medical and dental practice owners that is customized and specific to medical and dental practice numbers.

### CROSS-REFERENCE TO RELATED APPLICATIONS

The present application claims priority to U.S. Provisional Application No. 63/449,485 filed Mar. 2, 2023, titled “FINANCIAL DATA STORAGE AND ANALYSIS PLATFORM FOR HEALTHCARE INDUSTRY PROFESSIONALS AND PRACTICES” which is hereby incorporated by reference in its entirety.

### FIELD OF THE INVENTION

The present invention generally relates to a computer system for customized accounting platforms for medical and dental practice management.

### BACKGROUND OF THE DISCLOSURE

Dental/medical practice owners need to monitor the financial performance of themselves and their practices for a variety of reasons. These can include a desire to improve productivity, prevent waste, and others. Software platforms can provide a modern solution for recording and tracking this type of data. Up-to-date business and personal financial KPIs and analyses to execute financial plans are desirable.

Existing accounting software for dental and medical practices includes limited or no customization, is difficult to read, and often includes scattered financial data. Examples of existing systems include WO2001001321 which is a management system but not a financial platform; AU2002235670 which is billing software but does not include financial indicators; and WO2000072181 which is clinical only and does not include financial data.

There are no existing platforms that show practice productivity and expenses in a single, easy-to-navigate format. Thus, needs exist for practices to manage personal data related to important information and metrics in a single platform with time-specific tracking and analysis.

### SUMMARY OF THE INVENTION

The innovation described herein is related to a computer software or computer program that allows users to manage business and personal financial data for their medical and/or dental practice. The platform includes customizable features and specific data management.

In one aspect, important metrics can be measured, tracked, and displayed over different user desired time ranges and can include graphs and other data displays.

In one aspect, different types of practice software reports can be uploaded and imported in order to automate workflow.

In one aspect, banks and credit card CSV downloadable reports can be uploaded and imported to automate expense input processes and bookkeeping without the need for secondary or third-party integration.

In one aspect, profit and loss reports can be customized and produced for different timeframes.

In one aspect, year-end accounting reports can be prepared and reviewed.

In one aspect, multi-location, multi-provider individual, and collective data entry is facilitated and allows for simplified tracking and analysis.

In one aspect, specific modules are provided that are designed for practice productivity and expense tracking. These allow for annual analysis of important KPI's for the practice.

In one aspect, personal financial tracking modules can be provided to monitor net worth, expenses, income, assets, liabilities, and taxes paid.

### BRIEF DESCRIPTION OF THE DRAWINGS

The following Figures will demonstrate automatic functions for achieving automatic creating and updating the end-user screen images based on automotive data sources (ADS). The first three figures focus on the general method to achieve automatic creating and updating the end-user screen images based on automotive data sources (ADS) and the remaining seven figures illustrate the computer program flow charts and the logic behind each automatic operation as presented in this invention.

FIG. 1 is a system architecture diagram, according to some embodiments.

FIG. 2 is a data flowchart, according to some embodiments.

FIG. 3 is a screenshot of the business expense tracking module interface, according to some embodiments.

FIG. 4 is a screenshot of the business expense tracking module interface, according to some embodiments.

FIG. 5 is a screenshot of the profit and loss statement interface, according to some embodiments.

FIG. 6 is a screenshot of the main user interface, according to some embodiments.

FIG. 7 is a screenshot of the tax year report interface, according to some embodiments.

FIG. 8 is a flowchart of the system process flow, according to some embodiments.

### DETAILED DESCRIPTION OF THE INVENTION DISCLOSURE

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Various features included in embodiments allow medical/dental administrator users to successfully track and analyze their personal and practice financial situation. These can include one or more of the following:

Importing day-to-day practice financial summaries with parse-able data to save in a system account automatically and/or manually. Data can be uploaded in one or more of a variety of formats (e.g. .pdf) in various embodiments.

Non-administrator level or privileged users can be added to or have accounts created for them with the system. As such, these users can perform data entry and/or other non-administrative or other tasks. Such profiles may have limited access based on administrator users assigning limited functionality to such profiles.

Automatic reconciliation can be performed by non-administrative users and/or the platform with daily deposits and reported/posted income (e.g. on end-of-day reports). Appropriate users can be notified of any discrepancies to prevent fraud. Appropriate users can be required to approve the data after importation in order to ensure its accuracy and review and usernames and access timing can be timestamped and saved in memory as a reference for later review if needed.

End-of-day reports can be stored for future reference in the instance that an audit occurs and in order to prevent fraud, independent of any other third-party software operating with similar functionality.

CSV files can be automatically imported from accounts used to pay practice expenses in order to save them for each month. This can allow for customized bookkeeping on the platform. The system can generate accounting reports as desired and/or on-demand and can generate accounting reports for particular events, such as for tax reporting purposes to government agencies/bodies.

Multiple diverse geographical/physical locations can be tracked, along with doctors/dentists/medical professionals/owners/executives or others, and the system can separately store their financial data and tracking metrics for each. It can also aggregate the data for analytics related to overall performance.

KPIs can be accessed and analyzed using the system according to one or more appropriate time periods.

Personal financial metrics can be monitored for overall financial performance analysis. Examples include net worth, liabilities, assets, and others.

Data can be encrypted and saved on a remote platform (e.g. Amazon™ AWS platform). As such, the data can be remotely accessible by users, as needed.

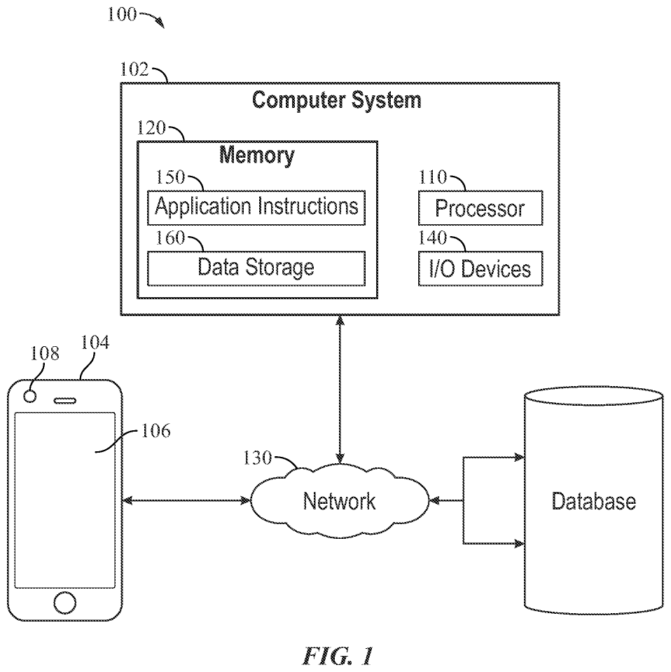

FIG. 1 illustrates a system architecture diagram 100, including a computer system 102, which can be utilized to provide and/or execute the processes described herein in various embodiments. The computer system 102 can be comprised of a standalone computer or mobile computing device, a mainframe computer system, a workstation, a network computer, a desktop computer, a laptop, a tablet, a smartphone, a videogame console, or the like. The computer system 102 includes one or more processors 110 coupled to a memory 120 via an input/output (I/O) interface. Computer system 102 may further include a network interface to communicate with the network 130. One or more input/output (I/O) devices 140, such as video device(s) (e.g., a camera), audio device(s), and display(s) are in operable communication with the computer system 102. In some embodiments, similar I/O devices 140 may be separate from computer system 102 and may interact with one or more nodes of the computer system 102 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 102 and other devices attached to a network 130, such as other computer systems, or between nodes of the computer system 102. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel storage area networks (SANs), or via any other suitable type of network and/or protocol.

The memory 120 may include application instructions 150, configured to implement certain embodiments described herein, and at least one database or data storage 160, comprising various data accessible by the application instructions 150. In at least one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 102 described in connection with the embodiments disclosed herein may be embodied directly in hardware, in a software module executed by a processor, or in a combination of the two. A software module may reside in random-access memory (RAM), flash memory, read-only memory (ROM) memory, erasable programmable read-only memory (EPROM) memory, electrically erasable programmable read-only memory (EEPROM) memory, registers, a hard disk, a solid-state drive (SSD), hybrid drive, dual-drive, a removable disk, a compact disc read-only memory (CD-ROM), digital versatile disc (DVD), high definition digital versatile disc (HD DVD), or any other form of non-transitory storage medium known in the art or later developed. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, Bluetooth, Wi-Fi, microwave, or others, then the coaxial cable, fiber optic cable, twisted pair, DSL, or wireless technologies such as infrared, radio, Bluetooth, Wi-Fi, microwave, or others can be included in the definition of medium. “Disk” and “disc,” as used herein, include compact disc (CD), laser disc, optical disc, digital versatile disc (DVD), floppy disk, and Blu-ray disc or others where disks usually reproduce data magnetically, while discs usually reproduce data optically with lasers. Combinations of the above should also be included within the scope of computer-readable media.

It should be understood by those in the art that computer system 102 also includes power components that are operably coupled such that the system is operable. This can include one or more batteries if computer system 102 is mobile.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device 102.

As shown in the example embodiment, a mobile computing device 104 can also be communicatively coupled with and exchange data with network 130. Those in the art will understand that mobile computing device 104 can include some or all of the same or similar components as computer system 102 coupled to constitute an operable device. Mobile computing device 104 can be a personal digital assistant (PDA), smartphone, tablet computer, laptop, a wearable computing device such as a smartwatch or smart glasses, or other devices that include one or more user interfaces 106, such as a touchscreen and/or audio input/output and/or other display and user input components. Mobile computing device 104 can also include one or more image capturing or reading components 108 (e.g. a digital camera, scanner, or others) and associated structures and elements operatively coupled to at least one processor and memory of the mobile computing device. Such image capturing component 108 can be operable to capture an image of a label and/or code (e.g. a quick response (QR) code or others) automatically or upon one or more user input commands.

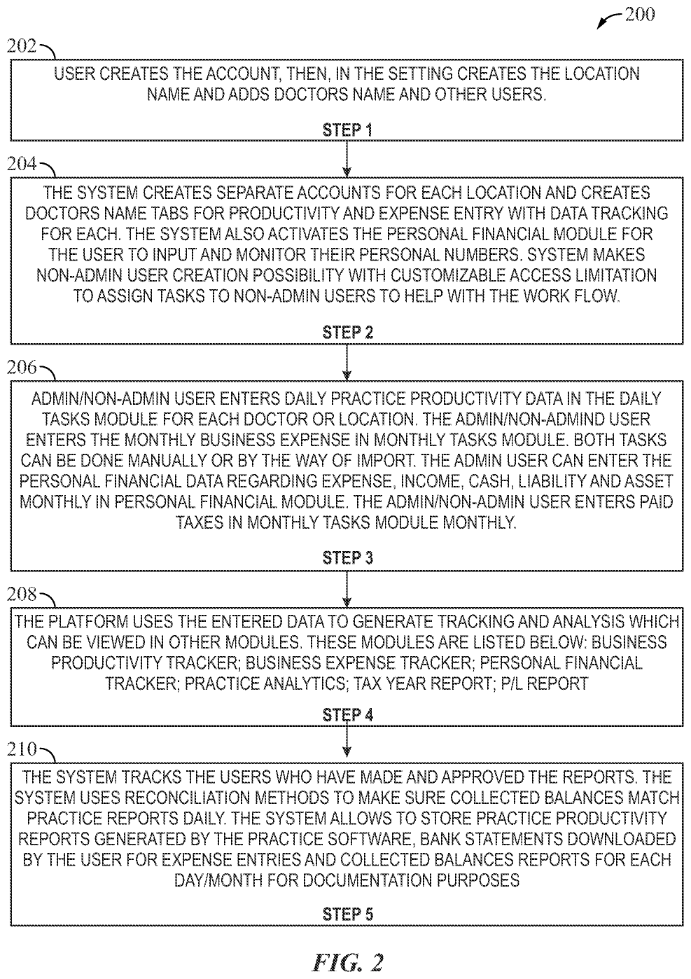

FIG. 2 shows a system operation flowchart 200, according to an example embodiment. As shown, a first step 202 can include a user creating an account. In a user settings section of the platform, the user can create or assign a office location/locations name and add doctors/dentists names and other users (such as non-admin users), support staff, employees and contractors.

In step 204, the system can create separate accounts associated with each physical location of a practice. Doctor/dentist name tabs can be created, selected, and/or assigned that can include one or more data entry fields or methods (e.g. uploading/importing) for information related to productivity and expenses. This information can then be automatically tracked by the system. The system is also operable to activate one or more personal financial module(s) for users to input and monitor personal financial data. The system can allow non-administrator user profile creation and allow customizable access limitations (protecting the privacy of admin users) in order to allow users to assign tasks to non-administrator users to assist with tasks that contribute to workflow.

In step 206, administrator and/or non-administrator user(s) are able to enter practice productivity data into task modules for each doctor and/or location. This can be performed on a regular or irregular basis, as appropriate. For example, tasks may be performed at certain times of day, daily, weekly, biweekly, monthly, quarterly, or on an as-needed basis. The user(s) can also enter business expenses in task modules. For example, monthly business expenses can be added in a monthly task module. These operations can be performed manually, automatically, or semi-automatically. As such, the system can track entered data, uploaded data, pulled or pushed data from other systems, applications, and/or modules, or others. Administrator users can also enter personal financial data regarding their expenses, income, cash, liability, and assets in a personal financial module, such as a monthly module. Administrator and/or non-administrator users can also enter taxes paid into an appropriate module, such as a monthly module.

In step 208, the platform can use data entered by users to generate tracking and analysis statistics that can be viewed in, by, or using other modules. These modules can include one or more of business productivity tracker(s), business expense tracker(s), personal financial tracker(s), practice analytics, tax year report, profit/loss report, and/or others, as desirable and/or appropriate.

In step 210, the system can allow track users who have generated and/or approved reports. Reconciliation methods, operations, and/or modules can be automatically employed to ensure balances match practice reports on a regular basis (e.g. daily). The system can also provide for storing practice productivity reports that are generated by the practice software platform, bank statements downloaded by the user for expense entries, collected balance reports for each day/month/quarter or otherwise, or others, for documentation purposes.

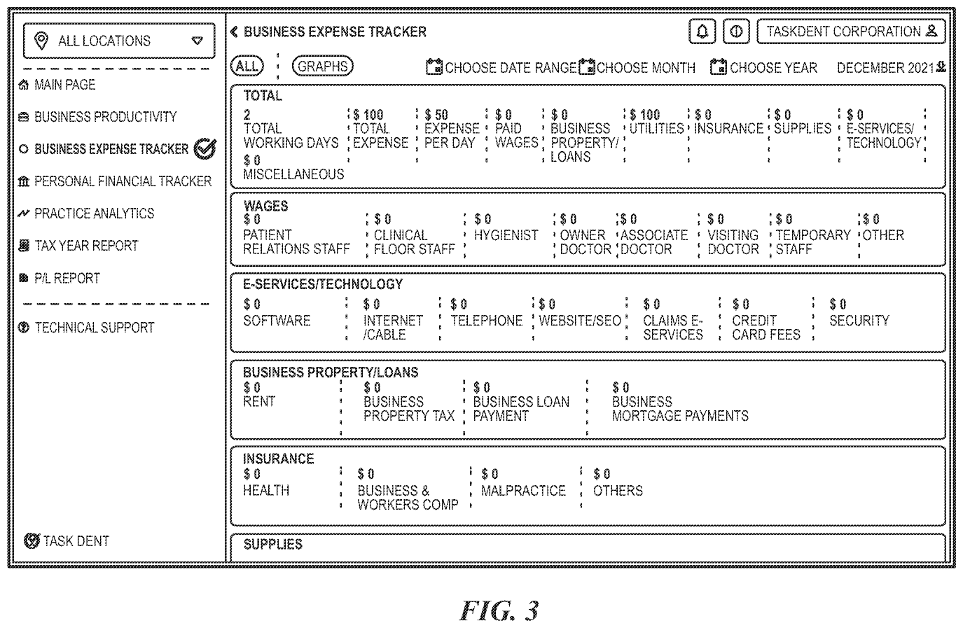

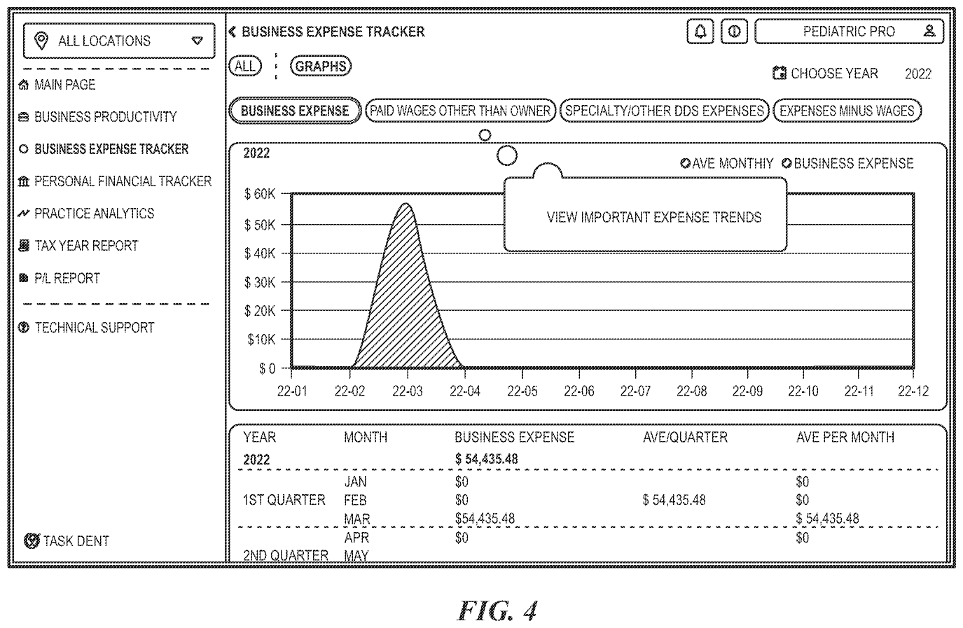

FIGS. 3-8 illustrate exemplary screenshots of the user interface of the system. In particular, FIG. 3 and FIG. 4 illustrate a screenshot of the business expense tracking module interface which is used to track a plurality of business expenses, view business expense data and other information. Data may be graphically organized, or organized in tables. Data may be filtered using various business aspects, time period, etc.

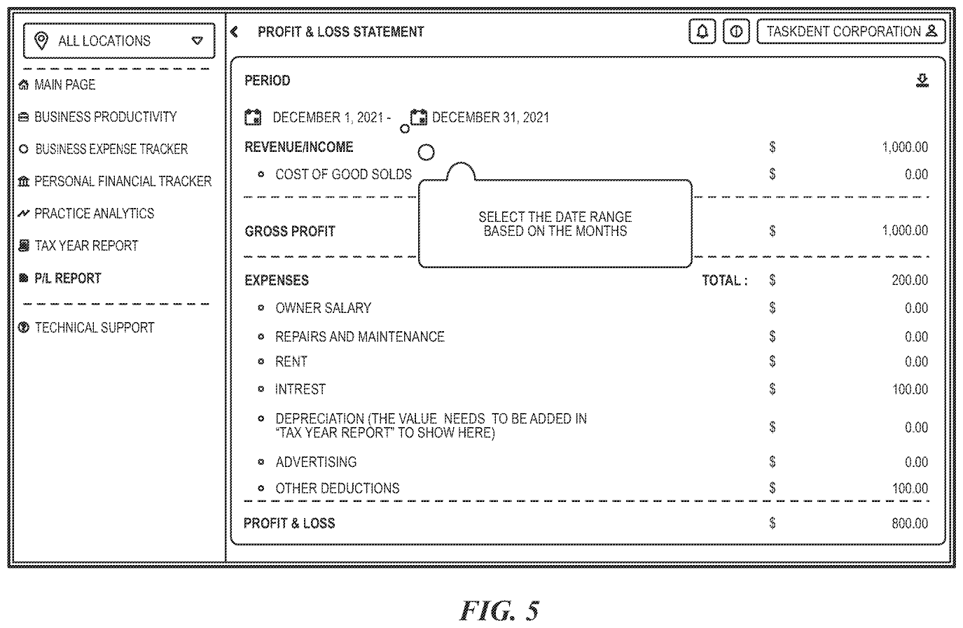

FIG. 5 illustrates a screenshot of the profit and loss statement interface which is utilized to view profit and loss data. This information may be viewed using various selectable metrics including time period, expense type, etc.

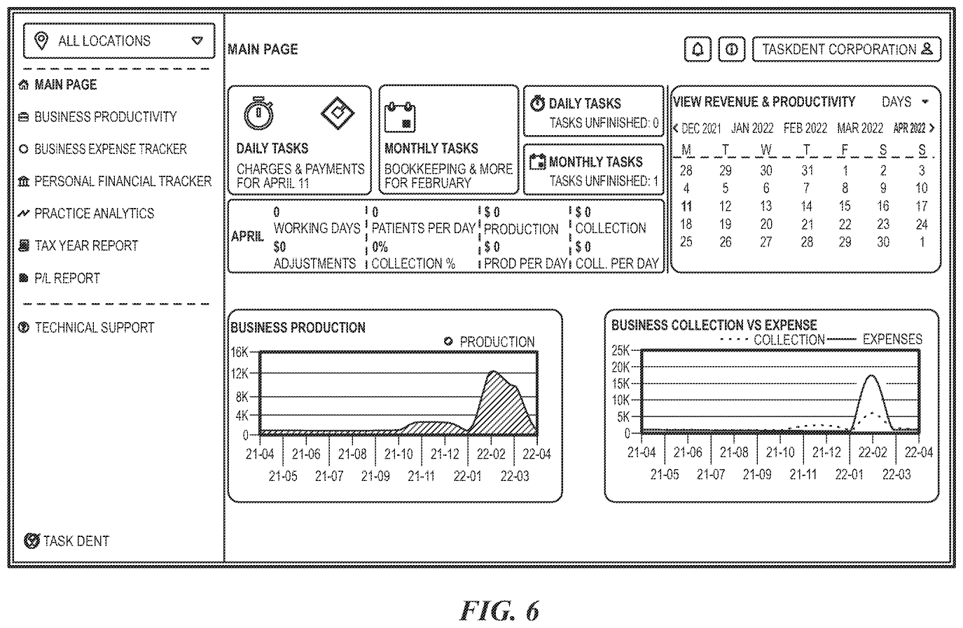

FIG. 6 illustrates a screenshot of the main dashbord user interface which may be utilized to view/complete daily and monthly tasks, view business production information and data, business collection and expense data, revenue data, etc.

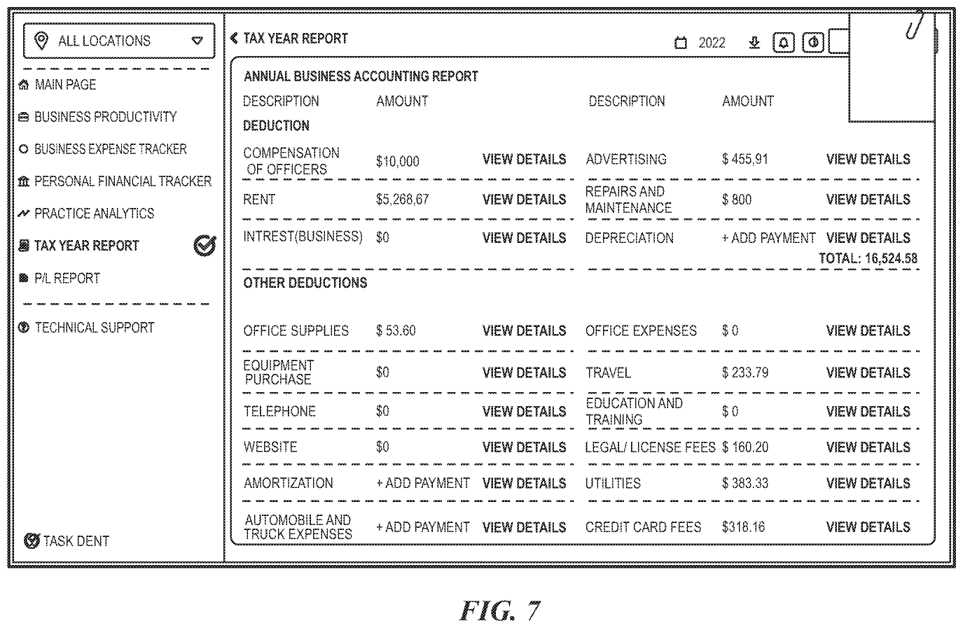

FIG. 7 illustrates a screenshot of the tax year report interface which may be utilized to view and monitor various tax information and data. This may include decuctions, transaction details, reports, etc which can also be used for tax preparation purposes.

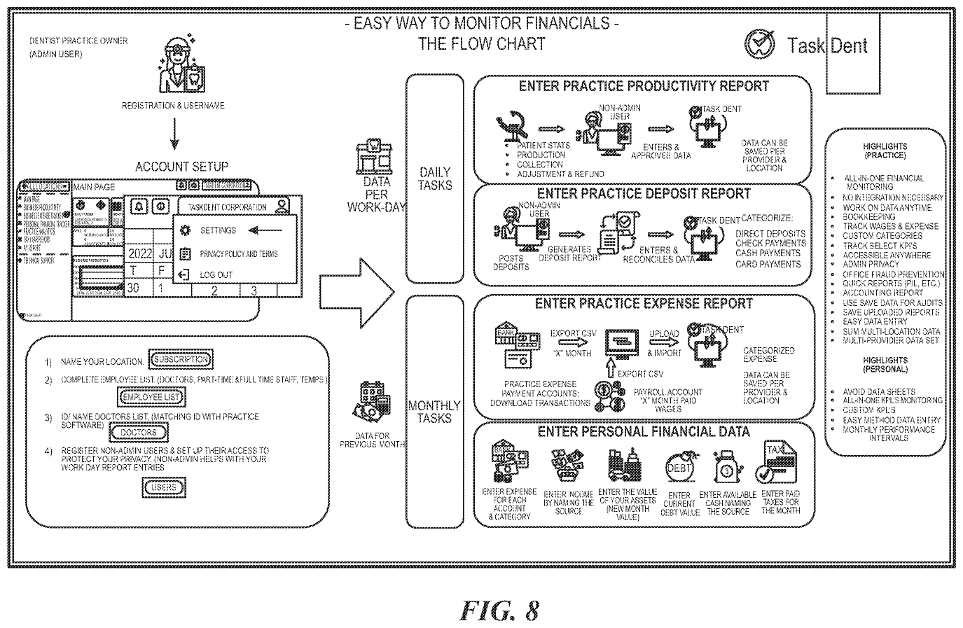

FIG. 8 illustrates a flowchart of the system process flow. Once an account is setup by the user or administrator, data from the previous work-day or month is entered to produce one of the following: a practice productivity report, a practice deposit report, a practice expense report, and/or personal financial data. Data may be processed by the system to produce “highlights” of various metrics.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances, entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

1. A computer-implemented method for automatically monitoring financial data in the healthcare industry, the method comprising the steps of:
instructions stored in a non-transitory computer-readable memory that, when executed by a processor, cause the processor to perform the steps of:
automatically tracking financial data for a healthcare entity;
providing one or more KPI's for the financial data; and
generating at least one report for user review based on the one or more KPI's.

2. The computer-implemented method of claim 1, wherein the healthcare entity is a doctor or a dentist.

3. The computer-implemented method of claim 1, wherein the healthcare entity is a healthcare practice.

4. The computer-implented method of claim 1, further comprising a business expense tracking module interface, facilitated by a display module, to display a plurality of business expenses.

5. The computer-implented method of claim 4, further comprising a profit and loss statement interface, facilitated by the display module, to display a plurality of profit and loss metrics associated with the healthcare entity.

6. The computer-implented method of claim 5, further comprising a tax year report interface, facilitated by the display module, to display a plurality of tax metrics.

7. The computer-implemented method of claim 1, further comprising a plurality of daily tasks.

8. The computer-implented method of claim 7, wherein the plurality of daily tasks include entering a practice productivity report manually or by way of import (no integration necessary).

9. The computer-implented method of claim 7, wherein the plurality of daily tasks include entering a practice deposit report manually or by way of import (no integration necessary).

10. The computer-implemented method of claim 1, further comprising a plurality of monthly tasks.

11. The computer-implemented method of claim 10, wherein the plurality of monthly tasks include entering a practice expense report manually or via importing and automatically assigning wage expenses to each employee.

12. The computer-implemented method of claim 10, wherein the plurality of monthly tasks include entering a plurality of practice financial data using data from daily and monthly modules.

13. The computer-implemented method of claim 1, further comprising the steps of:
creating an account including a location, a name, and a doctor name;
generating an expense entry associated with each doctor name and each location;
activating a personal financial module for each doctor name to permit the inputing and monitoring of a personal number associated with each doctor name;
entering, via a user, a plurality of daily practice productivity data;
entering, via the user, a plurality of monthly practice business expense data;
utilizing the plurality of daily practice productive data and the plurality of monthly practice business expense data to generate tracking and analysis information;
tracking a plurality of report data and compiling the plurality of report data into one or more documents.

14. A system for automatically monitoring financial data in the healthcare industry, the system comprising:
at least one user computing device in operable connection with a user network;
an application server in operable communication with the user network, the application server configured to host an application program for automatically monitoring financial data in the healthcare industry, the application program having a user interface module for providing access to the application program via the at least one computing device;
a processor to perform the steps of:
creating an account including a location, a name, and a doctor name;
generating an expense entry associated with each doctor name;
activating a personal financial module for each doctor name to permit the inputing and monitoring of a personal number associated with each doctor name;
entering, via a user, a plurality of daily practice productivity data;
entering, via the user, a plurality of monthly practice business expense data;
utilizing the plurality of daily practice productive data and the plurality of monthly practice business expense data to generate tracking and analysis information;
tracking a plurality of report data and compiling the plurality of report data into one or more documents.

15. The computer-implented method of claim 14, wherein a plurality of daily tasks include entering a practice productivity report.

16. The computer-implented method of claim 15, wherein the plurality of daily tasks include entering a practice deposit report.

17. The computer-implemented method of claim 16, further comprising a plurality of monthly tasks.

18. The computer-implemented method of claim 17, wherein the plurality of monthly tasks include entering a practice expense report.

19. The computer-implemented method of claim 18, wherein the plurality of monthly tasks include entering a plurality of practice financial data.
